(19) United States
(12) Patent Application Publication
(10) Pub. No.: US 2008/0158498 A1
(43) Pub. Date: Jul. 3, 2008

(54) Flexible display panel device

(75) Inventors: Chih-Hsiang Chang, Hsinchu (TW); Hsin-Hung Pan, Hsinchu (TW); Yung-Hui Yeh, Hsinchu (TW)

Correspondence Address: RABIN & Berdo, PC, 1101 14TH STREET, NW, SUITE 500, WASHINGTON, DC, 20005, US

(73) Assignee: INDUSTRIAL TECHNOLOGY RESEARCH INSTITUTE, Hsinchu (TW)

(21) Appl. No.: 11/976,680

(22) Filed: Oct. 26, 2007

(30) Foreign Application Priority Data
Dec. 29, 2006 (TW) 095150058

(51) Int. Cl. G02F 1/1333

(52) U.S. Cl. 349/158

(57) ABSTRACT

A flexible display panel device includes a plastic substrate with a display region and a peripheral region, a plurality of ribs disposed in the peripheral region and/or the display region, a discontinuous buffer layer disposed on the plastic substrate, and an active matrix component layer on a pixel disposed on the discontinuous buffer layer. During the fabrication of the flexible panel, a plastic substrate is first disposed on a carrier substrate for performing device fabrication. After the panel is finished, the plastic substrate is departed from the carrier substrate to form a flexible panel. Through the integration design of the ribs and discontinuous buffer layer, the flexible panel has preferred warp resistance and low stress, thereby enhancing the reliability and life time of the panel.

### CROSS-REFERENCE TO RELATED APPLICATIONS

This non-provisional application claims priority under 35 U.S.C. § 119(a) on Patent Application No(s). 095150058 filed in Taiwan, R.O.C. on Dec. 29, 2006, the entire contents of which are hereby incorporated by reference.

### BACKGROUND OF THE INVENTION

1. Field of Invention

The present invention relates to a display panel, and more particularly, to a flexible plastic substrate with preferred warp resistance and low warp displacement formed by a geometrical structure design of the plastic substrate and active matrix component, so as to enhance the reliability of the display panel.

2. Related Art

As for portable products, such as notebooks, personal digital assistants (PDAs), cell phones, digital cameras, and E-Books, the weight and space of the panel are mostly considered. Currently, the thickness of a glass substrate is about 0.5 mm; but, the plastic substrate is thinner and flexible, approximately 0.05 mm, and is lighter than the glass substrate, thus the plastic substrate has been a focus of attention as a next generation flexible display. Currently, the developing trends of plastic display process technology include a roll to roll printing process and an existing vacuum process apparatus. The vacuum process method is advantageous of not redesigning the process apparatus, and a glass substrate can be directly used as a carrier substrate (a carrier) of the plastic substrate. However, as the thermal expansion coefficients of the materials of a plastic and a glass substrate or an inorganic thin film transistor (TFT) component are significantly different, the plastic and glass substrates are seriously warped after a high temperature process, which may cause a severe offset in lithography, and thus influence the performance and yield of the inorganic TFT element.

Furthermore, as the Young's coefficient (elastic coefficient) and thickness of the plastic substrate is very small and thin, the plastic substrate shows a poor strain-resistance property. When the internal residual stresses are generated during a high temperature process, the plastic substrate may wrap and cannot be subjected to the subsequent processes, and thus influence the device performance.

### SUMMARY OF THE INVENTION

Accordingly, how to reduce the stress of the display panel, enhance the strain-resistance property=of the plastic substrate, and maintain certain flexibility have become important issues for flexible display.

As embodied and broadly described herein, a flexible display panel is provided. The flexible display panel includes a plastic substrate having a display region and a peripheral region, in which the display region is used for displaying images and the peripheral region is used for placing=drive IC chips; a plurality of ribs disposed on the peripheral region of the plastic substrate and/or between the active matrix component; the plastic substrate covered on a carrier substrate and the plurality of ribs; a discontinuous buffer layer disposed on the plastic substrate; and an active matrix component on a pixel disposed on the discontinuous buffer layer. The ribs, used for increasing the structural rigidity of the plastic substrate, are made of a plastic material having a high elastic coefficient and low thermal expansion coefficient. Furthermore, the discontinuous buffer layer can not only block gases and isolate impurities from entering the display panel, but also reduce the stress of the plastic substrate. With the integration design of the ribs and discontinuous buffer layer, the flexible panel shows better=warp resistance and low stress properties, thereby enhancing the reliability and life time of the panel.

Therefore, the present invention discloses a structure that may alleviate the warpage of the plastic substrate used for flexible display panel. Compared with a prior art, the present invention can reduce the internal stress of the plastic substrate, so as to reduce the warpage probability of the display panel in the high temperature process. Further, due to the ribs on the plastic substrate, the plastic substrate is not easily warpaged after a high temperature process. Moreover, the discontinuous buffer layer on the plastic substrate can disperse the structural stress of the entire plastic substrate, and can block gases and isolate impurities from entering the display panel. In addition, an active matrix component having a discontinuous pixel or discontinuous material layer can be used to alleviate the stress of the flexible panel in the prior art, thereby enhancing the reliability of the display panel.

The features and practice of the preferred embodiments of the present invention will be illustrated in detail below with the accompanying drawings. (The objectives, structures, features, and functions of the present invention will be illustrated in detail below accompanied with the embodiments.)

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus is not limitative of the present invention, and wherein:

FIG. 1A is a side view of a carrier substrate with ribs according to the present invention;

FIGS. 1B to 1D are top views of a carrier substrate with ribs according to the present invention;

FIG. 1E is a side view of the ribs disposed between the active matrix component according to the present invention;

FIG. 2A is a side view of the plastic substrate disposed on the carrier substrate and on the plurality of ribs in the peripheral region of the carrier substrate according to the present invention;

FIG. 2B is a side view of the plastic substrate disposed on the carrier substrate and on the plurality of ribs between the active matrix components according to the present invention;

FIGS. 3A to 3C are schematic views of the process of forming a discontinuous buffer layer on the plastic substrate according to the present invention;

FIG. 4 is a schematic view of the relation between the warp displacement of the plastic substrate with the ribs disposed thereon and the thickness of the ribs according to the present invention;

FIG. 5A is a side view of forming a discontinuous pixel on the discontinuous buffer layer according to the present invention;

FIG. 5B is a top view of an array structure formed by the stacking of the discontinuous buffer layer and the discontinuous pixel according to the present invention; and

FIG. 6 is a schematic view of the active matrix component on the pixel disposed on the discontinuous buffer layer according to the present invention.

### DETAILED DESCRIPTION OF THE INVENTION

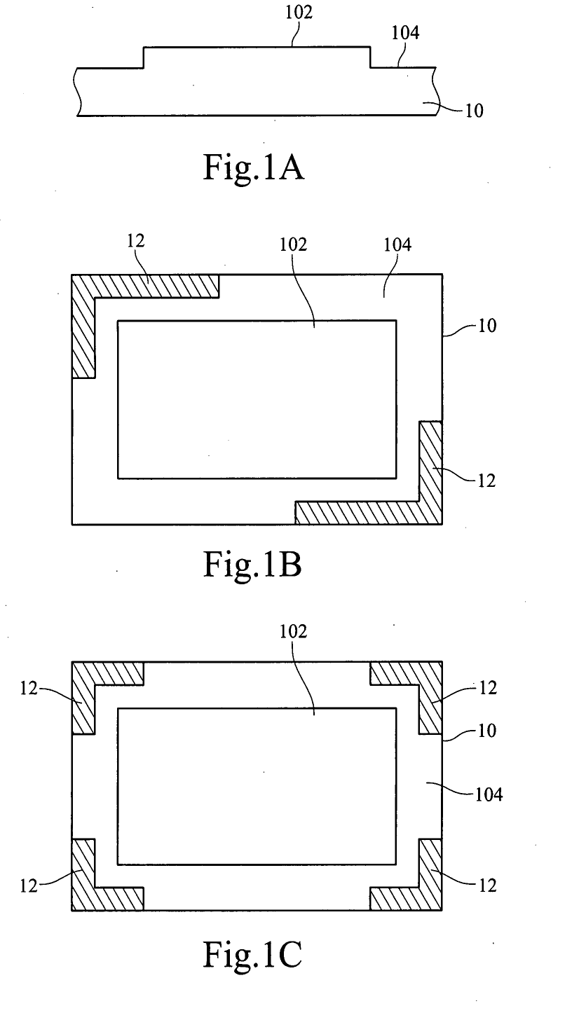

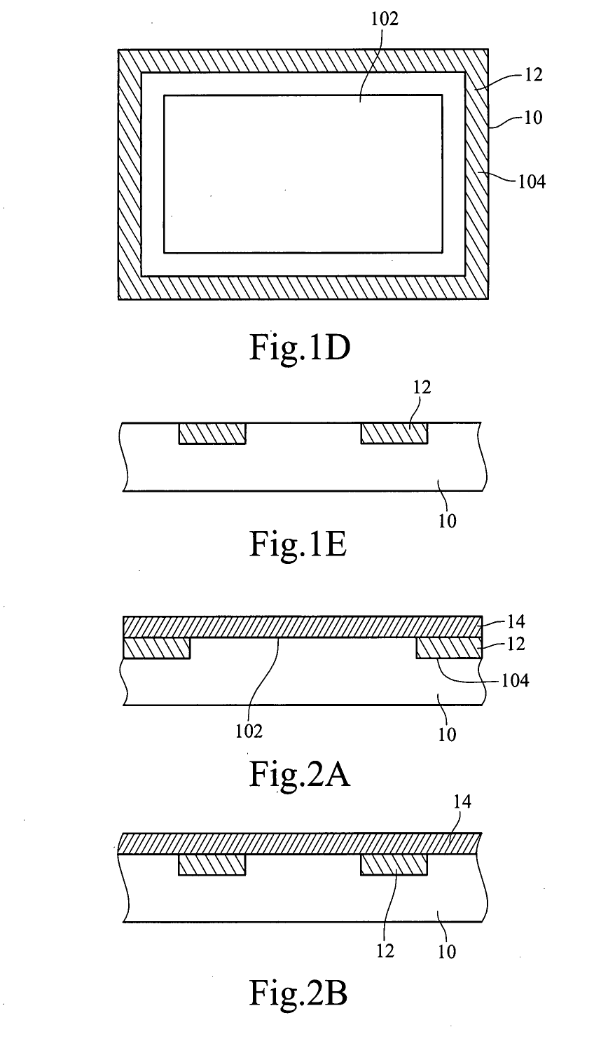

The embodiments of the present invention disclose a flexible display panel which integrates a liquid crystal or an organic light-emitting material and composed of an active matrix component (a-Si TFT/poly-Si TFT/thin film diode (TFD)/organic-TFT)) and a plastic substrate. FIG. 1A is a side view of a display panel substrate disclosed in the present invention. FIGS. 1B to 1D are top views of each example of a plurality of ribs placed on the substrate. FIG. 1E is a side view of a plurality of ribs disposed between the active matrix components. First, referring to FIG. 1A, a plastic substrate (or a carrier) 10 has a display region 102 and a peripheral region 104, in which the display region 102 is used for displaying images, and the peripheral region 104 is used for placing driving integrated circuit chips (drive IC chips). The thickness of the carrier substrate 10 is approximately 700 μm, and the carrier substrate 10 can be a glass substrate or other substrates of rigid materials, such as metal or ceramic materials, for carrying a plastic substrate (not shown).

As shown in FIG. 1B, in an embodiment, a plurality of ribs 12 is discontinuously disposed at two symmetrical corners on the peripheral region 104 of the carrier substrate 10. Or, in another preferred embodiment, as shown in FIG. 1C, the plurality of ribs 12 is respectively an L shaped configuration disposed at the four corners of the peripheral region 104 of the carrier substrate 10. Further, as shown in FIG. 1D, the ribs 12 of a continuous rectangular structure, for example, quadrate or square are placed on the peripheral region 104 of the carrier substrate 10. In this embodiment, the thickness of the ribs 12 disposed on the carrier substrate 10 is approximately 0.1 to 120 μm, and the width thereof is about 10% to 100% of that of the peripheral region 104. In FIG. 1E, according to another preferred embodiment of the present invention, a plurality of ribs 12 is disposed between the active matrix components (not shown) of the carrier substrate 10.

In the above embodiments, the ribs 12 are made of a plastic material, for example, polyimide (PI), with the elastic coefficient of approximately 7.5 to 250 GPa and thermal expansion coefficient of approximately 10 to 200 ppm. As the ribs 12 are disposed on the peripheral region 104 of the carrier substrate 10 for increasing the rigidity of the subsequent plastic substrate (not shown), such that the plastic substrate will not be wrapped during the subsequent high temperature process. Further, as the peripheral region 104 is used for placing drive IC chips thereon, the display of images and the transmission of a back light source will not be affected. It should be particularly noted herein that in this embodiment, the stated low thermal expansion coefficient indicates that the thermal expansion coefficient of the material is lower than 15 ppm (1×10⁻⁶).

Next, FIGS. 2A and 2B are side views illustrating the plastic substrate covered on a carrier substrate and the ribs, respectively. First, referring to FIG. 2A, the plastic material of the plastic substrate 14 is coated on the carrier substrate 10 and the plurality of ribs 12 in the peripheral region 104 of the carrier substrate 10. The thickness of the coated plastic material is approximately 20 to 200 μm, so the total thickness of the entire plastic substrate 14 and the peripheral region 104 of the ribs is 0.1 mm thicker than that of the display region 102. Further, referring to FIG. 2B, likewise, the plastic substrate 14 is coated on the carrier substrate 10 and the plurality of ribs 12 disposed on an active matrix component (not shown). In this embodiment, the elastic coefficient of the plastic substrate 14 is approximately 50 GPa to 250 GPa, the thermal expansion coefficient is approximately 10 ppm to 200 ppm, and the material thereof is, for example, PI. In this embodiment, the plastic substrate 14 and the ribs 12 with different elastic coefficients and thermal expansion coefficients are used in purpose, in which the ribs 12 of a higher elastic coefficient may enhance the rigidity of the structure of the plastic substrate 14 and the plastic substrate 14 of a lower elastic coefficient may make the display region 102 of the plastic substrate 14 maintain a high light transmittance property and flexibility.

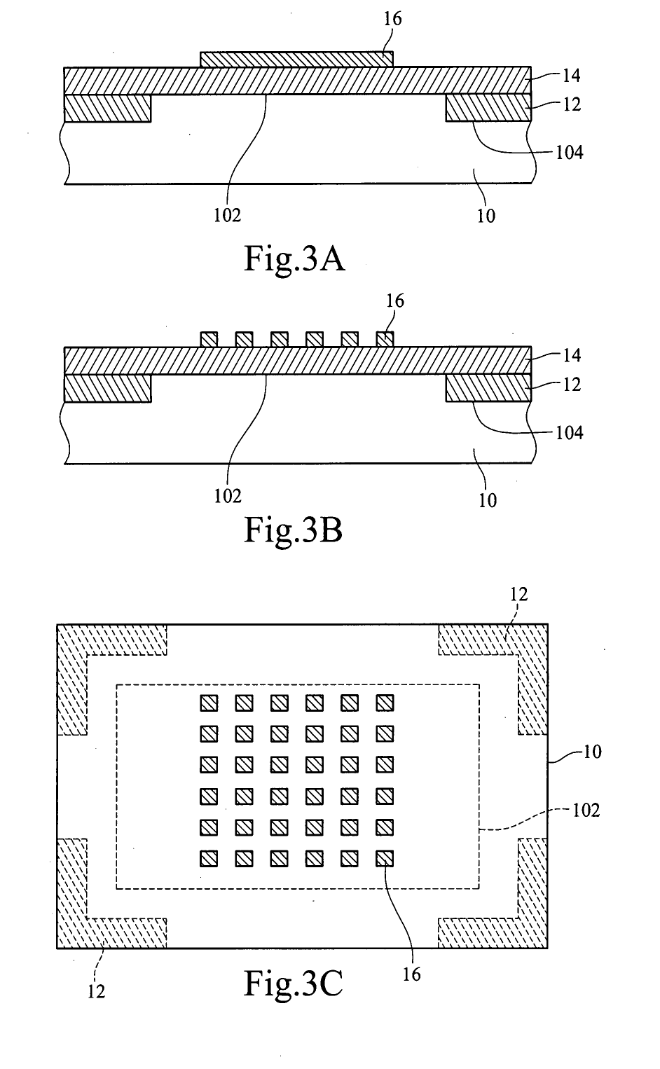

Afterwards, FIGS. 3A to 3C are schematic views of the process of forming a discontinuous buffer layer 16 on the plastic substrate 14. First, referring to FIG. 3A, a buffer layer 16 is disposed on the plastic substrate 14. Next, as shown in FIG. 3B, a discontinuous buffer layer 16 is formed on the plastic substrate 14 and above the display region 102 by means of patterning, such as lithography and etching. Further, it can be seen from the top view of FIG. 3C that the discontinuous buffer layer 16 is arranged in an array on the plastic substrate (not shown) and located above the display region 102 (marked by the dashed line in the figure) of the plastic substrate. As such, the discontinuous buffer layer 16 can be used to disperse the structural stress of the entire display panel, and meanwhile enhance the reliability of the display panel. Moreover, the discontinuous buffer layer 16 can be used to block gases or isolate impurities from entering the display panel, and it can be an inorganic or an organic/inorganic mixed material, such as SiO₂, Si₃N₄, SiOₓN_{y}, Al₂O₃, TiO₂, and Parylene/SiNₓ.

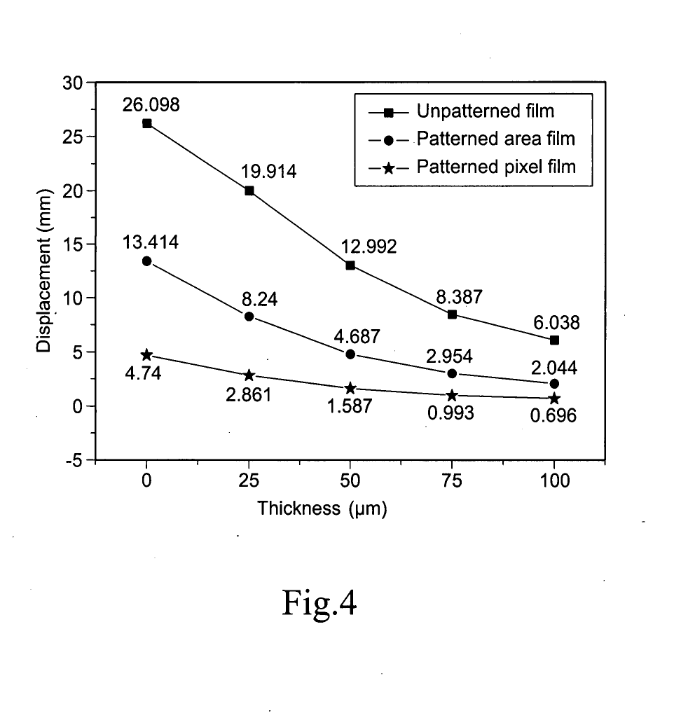

In view of the above, according to the research results, if the ribs 12 are placed on the peripheral region of the plastic substrate 14, the warp displacement of the panel can be reduced. FIG. 4 is a schematic view illustrating the relation between the warp displacement of the plastic substrate 14 with the ribs 12 disposed thereon and the thickness of the ribs 12. As shown in FIG. 4, a layer of 3000 Å thick SiO₂ thin film is coated on the plastic substrate 14 with an area of approximately 10 cm×10 cm. If the ribs 12 are not disposed on the peripheral region 104 of the plastic substrate 14, the warp displacement of the plastic substrate 14 (center and edge) may reach about 26 mm. If the ribs 12 are added, with the increase of the thickness of the ribs 12, the warp displacement of the plastic substrate 14 can be reduced by a factor of 4, i.e., only about 6 mm. If the buffer layer 16 is coated on the display region 102 only, the warp displacement of the plastic substrate 14 can be further reduced by a factor of 3, i.e., only about 2 mm. If the buffer layer 16 of the display region 102 is further designed into a discontinuous thin film, the warp displacement of the plastic substrate 14 can be further reduced by a factor of 3, i.e., only about 0.7 mm. Compared with the situation in the absence of the above design, after the structures of the plastic substrate 14 and the buffer layer 16 are re-designed, the warp displacement of the plastic substrate 14 can be reduced by a factor of 36.

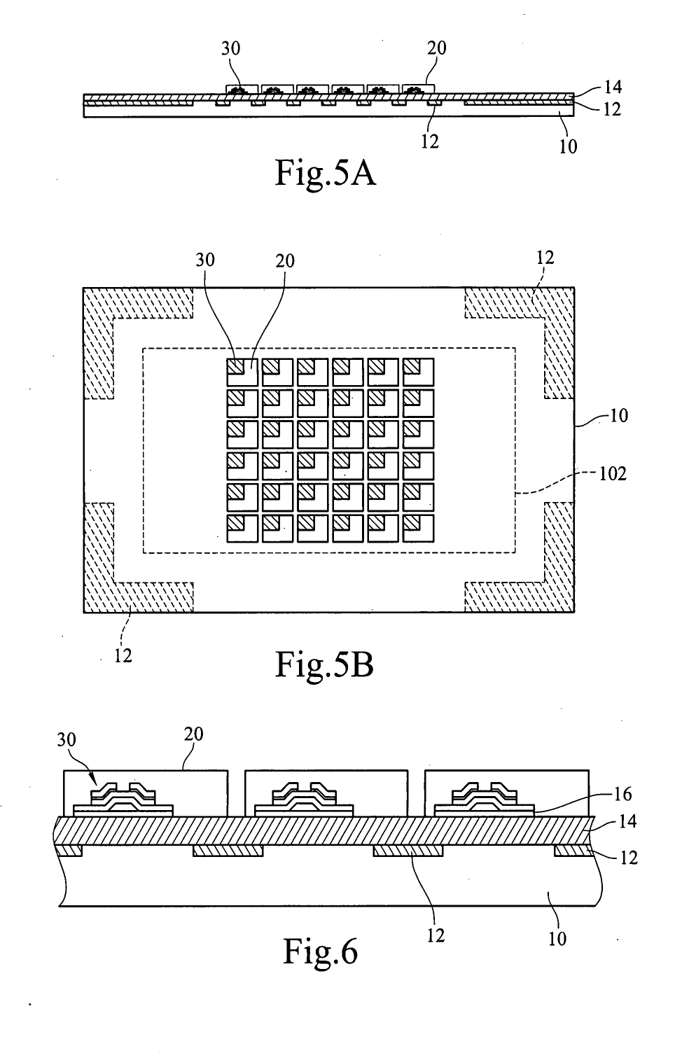

After that, referring to FIG. 5A, a discontinuous pixel 20 is formed on the discontinuous buffer layer 16 by means of vacuum coating, spin coating, screen printing, or ink jet printing. As shown FIG. 5B, a structure of discontinuous bright regions and dark regions is disposed on the plastic substrate 14. The bright regions are pixel regions formed by a plurality of pixels 20, and are light transmissive regions. The pixel regions are separately disposed in the display region of the plastic substrate. The dark regions are an active matrix component 30 and the buffer layer 16, in which the buffer layer 16 covers an area from the active matrix component 30 to the pixel regions.

Next, referring to FIG. 6, the active matrix component 30 on the pixel 20 is disposed on the discontinuous buffer layer 16, and the active matrix component 30 can be a transistor array element. Moreover, the structure of the active matrix component 30 includes a channel layer (not shown), a gate insulator layer (not shown), and a transparent conductive layer (not shown), which are discontinuously stacked on the discontinuous buffer layer 16 and located above the display region 102. The buffer layer 16 covers an area from the active matrix component 30 to the pixel regions. In this embodiment, the channel layer, gate insulator layer, and transparent conductive layer form a discontinuous structure because the channel layer, gate insulator layer, and transparent conductive layer respectively have a certain elastic coefficient.

It should be noted that extensibility refers to a ratio u between the breaking strain ε_{E} and the yield strain ε_{y} in a stress-strain curve of the material, i.e., u=ε_{E}/ε_{y}. When the value of u of the material is lower than 5, it can be referred to as a material of poor extensibility. Moreover, the material of the channel layer can be a-Si or poly-Si, the material of the gate insulator layer can be SiNx or SiOx, and the material of the transparent conductive layer can be ITO or IZO.

Thus, according to the above embodiments, the structural rigidity of the plastic substrate can be enhanced by the ribs. Moreover, the discontinuous buffer layer and the discontinuous pixel can be used to disperse the structural stress between the plastic substrate and the active matrix component and also reduce the warp stress. As such, through the improvement of the structure of the plastic substrate, the reliability and life time of the entire flexible display panel is enhanced.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A flexible display panel, integrating a liquid crystal or an organic light-emitting material and composed of at least one active matrix component (a-Si TFT/poly-Si TFT/thin film diode (TFD)/organic-TFT) and a plastic substrate, comprising:
the plastic substrate, having a display region and a peripheral region, the display region having a plurality of pixel regions which are separately disposed in the display region;
a plurality of ribs, disposed on the plastic substrate;
a pixel, stacked on the plastic substrate and on the display region; and
the active matrix component, stacked on the pixel.

2. The flexible display panel as claimed in claim 1, wherein the ribs are disposed on the peripheral region of the plastic substrate and/or between the active matrix components.

3. The flexible display panel as claimed in claim 1, wherein the ribs are of a discontinuous structure.

4. The flexible display panel as claimed in claim 3, wherein the discontinuous structure is L-shape, and is disposed on at least two diagonal corners of the peripheral region.

5. The flexible display panel as claimed in claim 1, wherein the ribs are of a continuous structure.

6. The flexible display panel as claimed in claim 4, wherein the continuous structure is rectangular-shaped.

7. The flexible display panel as claimed in claim 1, wherein the pixel is of a discontinuous structure.

8. The flexible display panel as claimed in claim 1, wherein the active matrix component further comprises a discontinuous material layer.

9. The flexible display panel as claimed in claim 8, wherein the discontinuous material layer comprises a channel layer, a gate insulator layer, and a transparent conductive layer.

10. A flexible display panel, integrating a liquid crystal or an organic light-emitting material and composed of at least one active matrix component (a-Si TFT/poly-Si TFT/thin film diode (TFD)/organic-TFT)) and a plastic substrate, comprising:
the plastic substrate, having a display region and a peripheral region, the display region having a plurality of pixel regions which are separately disposed in the display region;
a buffer layer, stacked on the pixel regions;
a pixel, stacked on the buffer layer and on the display region; and
the active matrix component, stacked on the buffer layer and the display region.

11. The flexible display panel as claimed in claim 10, further comprising a plurality of ribs disposed on the peripheral region of the plastic substrate and/or between the active matrix components.

12. The flexible display panel as Claimed in claim 11, wherein the ribs are of a discontinuous structure.

13. The flexible display panel as claimed in claim 12, wherein the discontinuous structure is L-shaped, and is disposed on at least two diagonal corners of the peripheral region.

14. The flexible display panel as claimed in claim 10, wherein the ribs are of a continuous structure.

15. The flexible display panel as claimed in claim 14, wherein the continuous structure is rectangular-shaped.

16. The flexible display panel as claimed in claim 10, wherein the buffer layer covers an area from the active matrix component to the pixel regions.

17. The flexible display panel as claimed in claim 10, wherein material of the buffer layer is an inorganic material or an organic/inorganic mixed material.

18. The flexible display panel as claimed in claim 10, wherein material of the buffer layer is one selected from a group consisting of SiO₂, Si₃N₄, SiOₓN_{y}, Al₂O₃, TiO₂, and Parylene/SiNₓ.

19. The flexible display panel as claimed in claim 10, wherein the active matrix component further comprises a discontinuous material layer.

20. The flexible display panel as claimed in claim 19, wherein the discontinuous material layer comprises a channel layer, a gate insulator layer, and a transparent conductive layer.
